(19) United States
(12) Patent Application Publication
(10) Pub. No.: US 2026/0311109 A1
(43) Pub. Date: Oct. 8, 2026

(54) ITEM DELIVERY METHOD AND APPARATUS BASED ON COMMA ADDRESS, AND COMPUTER DEVICE

(71) Applicant: CHANGSHA XINGSHEN INTELLIGENT TECHNOLOGY CO., LTD, Changsha (CN)

(72) Inventors: Xiangjing AN, Changsha (CN); Qiu ZHANG, Changsha (CN); Shuai LIU, Changsha (CN)

(73) Assignee: CHANGSHA XINGSHEN INTELLIGENT TECHNOLOGY CO., LTD, Changsha (CN)

(21) Appl. No.: 19/506,589

(22) PCT Filed: Dec. 1, 2024
(86) PCT No.: PCT/CN2024/072000

§ 371 Date: Jan. 29, 2026

(30) Foreign Application Priority Data
Aug. 4, 2023 (CN) 202310977962.1

(51) Int. Cl. G06Q 10/083; G06F 40/205

(52) U.S. Cl. CPC G06Q 10/08355; G06F 40/205

(57) ABSTRACT

An item delivery method based on a comma address includes: acquiring an encrypted identifier of a comma address corresponding to a delivery address, and parsing the encrypted identifier to obtain text information, where the comma address refers to a precise address including two levels of addresses: a major address and a minor address; obtaining, based on the text information, the comma address that meets an address filling requirement of a delivery server; sending the comma address to the delivery server, such that the delivery server performs dispatching based on the major address field in the comma address and delivers a to-be-delivered item to a courier station; and dispatching a transport unit to the courier station, such that the transport unit identifies the minor address field in the comma address and delivers the to-be-delivered item to the delivery address. The method can enhance delivery efficiency and solve a user privacy problem.

### CROSS REFERENCE TO THE RELATED APPLICATIONS

This application is the national phase entry of International Application No. PCT/CN2024/072000, filed on Jan. 12, 2024, which is based upon and claims priority to Chinese Patent Application No. 202310977962.1, filed on Aug. 4, 2023, the entire contents of which are incorporated herein by reference.

### TECHNICAL FIELD

The present disclosure relates to the technical field of intelligent delivery, and in particular, to an item delivery method and apparatus based on a comma address, and a computer device.

### BACKGROUND

With the advancement of computer technologies, the logistics industry has also experienced significant development. Initially, logistics involves item delivery between cities, where a consignor delivers an item to a logistics site, and a consignee fetches the item at another logistics site. With the rise of online shopping, logistics has evolved to enable direct home delivery. However, when making a delivery, a delivery person often encounters a conflict with a consignee regarding delivery time. Consequently, last-mile delivery has become a critical step in a logistics chain.

In existing last-mile delivery scenarios for logistics operations, handing over and signing for the item typically requires both parties to be present at an agreed location and time. In practice, based on the address and user information on a package label for the item, the delivery person usually delivers the item to a consignee address provided by a user, and notifies the user by phone to fetch the item. However, situations often arise where no one is available at home when the item is sent to the consignee address. To address this problem, solutions such as courier stations and parcel lockers have emerged. Although these courier stations and parcel lockers address time constraints, they do not fully address the spatial constraints of last-mile delivery.

### SUMMARY

Based on this, it is necessary to provide an item delivery method and apparatus based on a comma address, and a computer device, so as to address the aforementioned technical problems.

An item delivery method based on a comma address includes:
acquiring an encrypted identifier of a comma address corresponding to a delivery address, and parsing the encrypted identifier to obtain text information, where the comma address refers to a precise address including two levels of addresses: a major address and a minor address;
obtaining, based on the text information, the comma address that meets an address filling requirement of a delivery server;
sending the comma address to the delivery server, such that the delivery server performs dispatching based on a major address field in the comma address to deliver a to-be-delivered item to a courier station; and
dispatching a transport unit to the courier station, such that the transport unit identifies a minor address field in the comma address and delivers the to-be-delivered item to the delivery address.

In an embodiment, the item delivery method further includes: receiving a physical address and user-defined information that are filled in by a user through a handheld terminal, acquiring user identity (ID) information, and obtaining, based on the physical address, the user-defined information and the user ID information, the encrypted identifier corresponding to the comma address; or receiving interaction information obtained by the user scanning an address identifier corresponding to the delivery address through the handheld terminal, and obtaining, based on the interaction information, the encrypted identifier of the comma address corresponding to the delivery address.

In an embodiment, the item delivery method further includes: acquiring pre-collected user ID information and a physical address, and obtaining, based on the physical address and the user ID information, the encrypted identifier of the comma address corresponding to the delivery address.

In an embodiment, the encrypted identifier is at least one of a quick response (QR) code, a mini-program QR code, a barcode, and a recognizable code sequence.

In an embodiment, the major address field indicates a plaintext address pointing to the courier station.

In an embodiment, the minor address field indicates a ciphertext address pointing from the courier station to the delivery address.

In an embodiment, the minor address field includes a location identifier and user information; and the item delivery method further includes: performing matching based on the location identifier to obtain a physical address corresponding to the comma address, and performing matching based on the user information to obtain the user ID information.

In an embodiment, the user information is information filled in and registered by a user through a handheld terminal; or the user information is information generated based on preset conversion logic after the user ID information is acquired.

In an embodiment, the transport unit is a delivery person equipped with a handheld terminal; and the item delivery method further includes: identifying, by the delivery person, the minor address field in the comma address through the handheld terminal, and obtaining the physical address corresponding to the comma address and the ID information; and delivering the to-be-delivered item to the delivery address based on the physical address corresponding to the comma address and the ID information.

In an embodiment, the transport unit is a robot module; and the item delivery method further includes: identifying, by the robot module, the minor address field in the comma address, and obtaining the physical address corresponding to the comma address and the ID information; and delivering the to-be-delivered item to the delivery address based on the physical address corresponding to the comma address and the ID information.

An item delivery apparatus based on a comma address includes:
a text acquisition module configured to acquire an encrypted identifier of a comma address corresponding to a delivery address, and parse the encrypted identifier to obtain text information, where the comma address refers to a precise address including two levels of addresses: a major address and a minor address;
a standard address parsing module configured to obtain, based on the text information, the comma address that meets an address filling requirement of a delivery server;
a first delivery module configured to send the comma address to the delivery server, such that the delivery server performs dispatching based on a major address field in the comma address to deliver a to-be-delivered item to a courier station; and
a second delivery module configured to dispatch a transport unit to the courier station, such that the transport unit identifies a minor address field in the comma address and delivers the to-be-delivered item to the delivery address.

A computer device includes a memory and a processor, where the memory stores a computer program, and the processor executes the computer program to perform following steps:
acquiring an encrypted identifier of a comma address corresponding to a delivery address, and parsing the encrypted identifier to obtain text information, where the comma address refers to a precise address including two levels of addresses: a major address and a minor address;
obtaining, based on the text information, the comma address that meets an address filling requirement of a delivery server;
sending the comma address to the delivery server, such that the delivery server performs dispatching based on a major address field in the comma address to deliver a to-be-delivered item to a courier station; and
dispatching a transport unit to the courier station, such that the transport unit identifies a minor address field in the comma address and delivers the to-be-delivered item to the delivery address.

A computer-readable storage medium stores a computer program, where the computer program is executed by a processor to perform following steps:
acquiring an encrypted identifier of a comma address corresponding to a delivery address, and parsing the encrypted identifier to obtain text information, where the comma address refers to a precise address including two levels of addresses: a major address and a minor address;
obtaining, based on the text information, the comma address that meets an address filling requirement of a delivery server;
sending the comma address to the delivery server, such that the delivery server performs dispatching based on a major address field in the comma address to deliver a to-be-delivered item to a courier station; and
dispatching a transport unit to the courier station, such that the transport unit identifies a minor address field in the comma address and delivers the to-be-delivered item to the delivery address.

Different from existing delivery methods, the item delivery method and apparatus based on a comma address, the computer device, and the storage medium that are described above innovatively propose a concept of a comma address for an existing delivery address, where the comma address refers to a precise address including two levels of addresses: a major address and a minor address, so as to form spatial division. The spatial division has two advantages. First, traditional delivery persons only need to deliver an item to a courier station, and neither need to pay attention to a consignee and a detailed address, nor need to notify or contact a customer, thereby ensuring security of user information. Second, a user does not have to go to a traditional courier station to look for the item, but waits for a transport unit to directly deliver the item to a final precise address indicated by the comma address.

### BRIEF DESCRIPTION OF THE DRAWINGS

FIG. 1 is a diagram of an application scenario of an item delivery method based on a comma address according to an embodiment;

FIG. 2 is a schematic flowchart of an item delivery method based on a comma address according to an embodiment;

FIG. 3 is a flowchart of a typical business according to an embodiment;

FIG. 4 is a structural block diagram of an item delivery apparatus based on a comma address according to an embodiment; and

FIG. 5 is an internal structural diagram of a computer device according to an embodiment.

### DETAILED DESCRIPTION OF THE EMBODIMENTS

To make the objectives, technical solutions, and advantages of the present disclosure clearer, the present disclosure is further described in detail below with reference to the accompanying drawings and embodiments. It should be understood that the specific embodiments described herein are merely used to explain the present disclosure, rather than to limit the present disclosure.

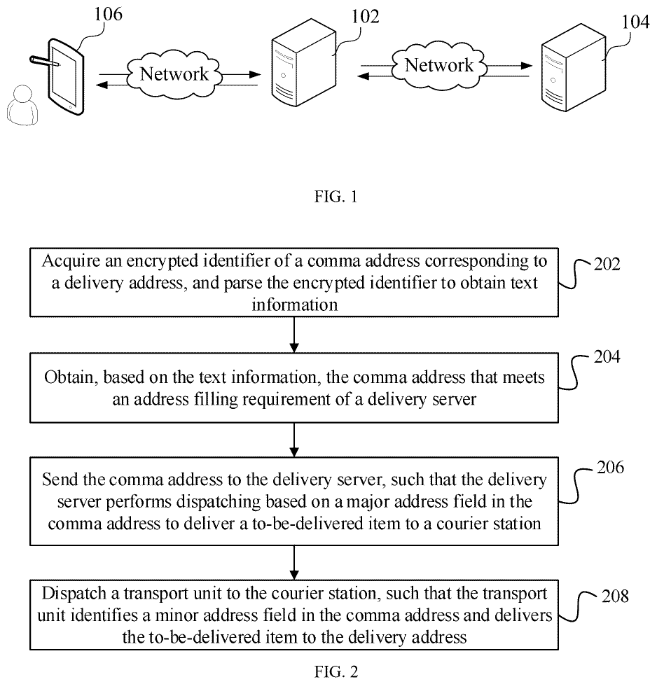

An item delivery method based on a comma address provided in the present disclosure may be applied to an application environment shown in FIG. 1. Server 102 is a server configured to implement item delivery based on a comma address. The server 102 can store information of all comma addresses, generate a new comma address based on user information and a physical address, parse the comma address, and the like. Delivery server 104 is a third-party server, such as a server of Meituan, JD.com, or Ele.me. Currently, an address filling rule of the third-party server needs to be followed to place an order on the third-party server. To obtain a comma address that meets an address filling requirement of the delivery server, an encrypted identifier of the comma address can be parsed to obtain text information. It should be noted that the text information does not contain actual address information. Instead, an address indicated in the text information can point to an actual physical address and user information based on a mapping relationship stored in the server 102. Transport unit 106 may be a delivery person or a robot. A minor address field can be identified by the delivery person through a handheld terminal, or by the robot, such that the transport unit not only can deliver an item to an exact delivery address but also can verify an ID of a user.

In an embodiment, as shown in FIG. 2, an item delivery method based on a comma address is provided. Taking application of the item delivery method to the server in FIG. 1 as an example for description, the item delivery method includes the following steps:

Step 202: An encrypted identifier of a comma address corresponding to a delivery address is acquired, and the encrypted identifier is parsed to obtain text information.

The encrypted identifier serves as an entry for interaction between a user and the server. The encrypted identifier may be generated based on pre-collected address information and user information, or may be generated after the interaction with the user.

The delivery address is an actual address to which an item is delivered, for example, Workstation 1, 4th Floor, Building XX, XX New City, Changsha County, Changsha City, Hunan Province. The comma address refers to a precise address including two levels of addresses: a major address and a minor address.

The major address is a unique and accurate actual address that can be directly read and identified by the user or a delivery person, including a drop-down address and a house number. Taking the above delivery address as an example, the drop-down address is Science and Technology New City, Changsha County, Changsha City, Hunan Province, and the house number is West Gate courier station, which may also be a property management office, a duty room, a Furong Xingsheng, or the like. It is worth noting that the user or the delivery person can determine the delivery address after identifying the major address.

The minor address is an encrypted address, which can be identified by a delivery person with a decryption device or by a robot through interaction with the server. The delivery person can decrypt the encrypted address through the decryption device to obtain mnemonic text, or the robot scans the encrypted identifier to read a location, a username, and a mobile phone number of a consignee. The minor address is composed of Chinese characters, letters, and numbers individually or in combination, and includes a point location and a user ID. Taking Building XX of XX New City as an example, the location point is the workstation 1 on the 4th floor, and the user ID is a custom code, for example, the username+the last four digits of the mobile phone number.

Step 204: The comma address that meets an address filling requirement of a delivery server is obtained based on the text information.

Step 206: The comma address is sent to the delivery server, such that the delivery server performs dispatching based on a major address field in the comma address to deliver a to-be-delivered item to a courier station.

It should be noted that a standard address contains the major address field, which can thus guide the delivery person to deliver an item to an address indicated by the major address field without a need to parse information of a minor address field. This not only ensures information security of the user but also improves work efficiency of the delivery person.

The courier station may be an intelligent courier station, such as an intelligent delivery station, an atomic locker, or another smart station.

Step 208: A transport unit is dispatched to the courier station, such that the transport unit identifies the minor address field in the comma address and delivers the to-be-delivered item to the delivery address.

The transport unit may be an unmanned vehicle for autonomous delivery, a robot, or the like, or may be a delivery person equipped with a handheld terminal, which is not specifically limited herein. It is worth noting that the transport unit is only required to be capable of recognizing the minor address field in the comma address and have a mobility capability.

Different from existing delivery methods, the above item delivery method based on a comma address innovatively proposes a concept of a comma address for an existing delivery address, where the comma address refers to a precise address including two levels of addresses: a major address and a minor address, so as to form spatial division. The spatial division has two advantages. A first advantage is that traditional delivery persons only need to deliver an item to a courier station, and neither need to pay attention to a consignee and a detailed address, nor need to notify or contact a customer, thereby ensuring security of user information. A second advantage is that a user does not have to go to a traditional courier station to look for the item, but waits for a transport unit to directly deliver the item to a final precise address indicated by the comma address.

In an embodiment, the user fills in a physical address and user-defined information through a handheld terminal. The server receives the physical address and the user-defined information, acquires user ID information, and obtains, based on the physical address, the user-defined information and the user ID information, the encrypted identifier corresponding to the comma address. Therefore, it can be concluded that the encrypted identifier contains at least the physical address, the user-defined information, and the user ID information. Therefore, physical information can be obtained by parsing the encrypted identifier, and the user ID can also be confirmed for last-mile delivery, thereby achieving an effect of protecting user privacy.

In an embodiment, the encrypted identifier is at least one of a QR code, a mini-program QR code, a barcode, and a recognizable code sequence. It can be concluded that the QR code, the mini-program QR code, the barcode, and the recognizable code sequence are all information carrying modes. An operator of the server can manage encrypted identifiers within a region. Specifically, the operator pastes images of the QR code, the mini-program QR code, the barcode, and the recognizable code sequence at fixed locations for users in the corresponding locations to use. In first-time use, the user scans the image of the QR code, the mini-program QR code, the barcode, or the recognizable code sequence through a terminal to interact with the server. The user fills in the physical address and the user-defined information, and obtains the user ID information during the interaction. Thus, the user establishes a corresponding relationship with the encrypted identifier based on the above information. In subsequent use, the user only needs to scan the image of the QR code, the mini-program QR code, the barcode, or the recognizable code sequence to directly obtain the required text information, which brings great convenience to the user.

In another embodiment, interaction information obtained by the user scanning an address identifier corresponding to the delivery address through the handheld terminal is received, and the encrypted identifier of the comma address corresponding to the delivery address is obtained based on the interaction information.

It is worth noting that the encrypted identifier is formed to convert plaintext information such as the user address and the user information into a combination of reserved plaintext and ciphertext in accordance with a specific rule, which is then stored in the server. For the recognizable plaintext, the delivery person can deliver the item to a designated location (namely, the courier station). For the ciphertext, corresponding plaintext contained therein can be obtained through interaction with the server, thereby protecting the user privacy.

With the expansion of specific applications in the present disclosure, in a possible implementation, the operator collects information of each management point location in the region in advance. Specifically, the operator collects an actual physical addresses and user ID information of the point location, and generates an encrypted identifier based on the above information. The encrypted identifier is then pasted at the corresponding point location in a form of the QR code, the mini-program QR code, the barcode, or the recognizable code sequence, thereby achieving rapid and comprehensive deployment of comma addresses across the region.

It is worth noting that in the first-time use, the user identifies the encrypted identifier through a user terminal and establishes an interactive connection with the server. In this case, the user can edit the user ID information in the encrypted identifier, especially user information that is displayed in plaintext.

In an embodiment, the major address field indicates a plaintext address pointing to the courier station. A key of the present disclosure lies in not changing a usage habit of any party in an entire delivery system. The delivery person can deliver the item to the designated courier station accurately based on the major address field in the comma address, without a need to perform any additional operation. In this way, no learning cost is involved in terms of usage, and on the contrary, efficiency of the delivery person can be improved.

In another embodiment, the minor address field indicates a ciphertext address pointing from the courier station to the delivery address. Since the minor address field indicates the ciphertext address, even if the delivery person views the ciphertext address, the delivery person cannot obtain a specific address of the user. Furthermore, under a system constructed by the present disclosure, the delivery person does not need to understand specific content of the ciphertext address and only needs to deliver the item to the designated courier station. In the present disclosure, a space is divided into a large space and a small space, which are respectively corresponding to the major address and the minor address. The large space is a space for which the delivery person is responsible, that is, a space where regular delivery is carried out based on the major address. The small space is a space with the courier station as a connection point. Within the small space, a large number of comma addresses are managed by the server. Under unified management of the server, these comma addresses are characterized by on-demand maintenance, rapid adjustment, and high precision, thereby achieving address digitalization and grid-based community management within a physical space corresponding to the small space. With an encrypted identifier set at any location within the small space, the user can interact with the encrypted identifier, enabling the server to obtain the text information, such that the user copies the text information, and fills in the text information on order-placing platforms such as Taobao, JD.com, Meituan, and Ele.me, or jumps to a corresponding website to fill the text information after selecting a service type.

In an embodiment, the minor address field includes a location identifier and the user information; and matching is performed based on the location identifier to obtain a physical address corresponding to the comma address, and matching is performed based on the user information to obtain the user ID information. In this embodiment, the minor address field is parsed at an end step of a delivery process. Regardless of whether the delivery is executed by the delivery person or an unmanned vehicle, both a definite physical address and a clear user ID are required. The final delivery can be completed once the delivery person or the unmanned vehicle arrives at the physical address and verifies the user ID.

In this embodiment, the location identifier is also distinct from the actual physical address. For example, the physical address is the workstation 1 on the 4th floor, whereas the location identifier may be Dragon Gate Inn. The server actually stores a corresponding relationship between the Dragon Gate Inn and the workstation 1 on the 4th floor. This realizes encryption of the physical address, thereby further achieving encryption of the user privacy on the whole.

Specifically, the user information is information filled in and registered by the user through the handheld terminal, which is different from the user ID information. The user ID information is real and identifiable user information, such as a real name and a real mobile phone number. In contrast, the user information is information that can be used to verify the user ID, such as a nickname, a digital code, or a combination thereof, so as to encrypt the user ID.

In addition, if the user information is generated by using the preset conversion logic, the user information may be composed of, for example, a part of the name and a part of the mobile phone number, and to a certain extent, the user ID can also be encrypted.

In an embodiment, the transport unit is the delivery person equipped with the handheld terminal. The handheld terminal can decode the minor address field to obtain the physical address corresponding to the comma address and the ID information, and then the to-be-delivered item is delivered to the delivery address based on the physical address corresponding to the comma address and the ID information.

In this embodiment, a specific application (APP) is installed in the handheld terminal, which can be linked to the server. Through interaction with the server, the APP can obtain the physical address and the ID information through parsing. For the delivery person, the physical address and the ID information are plaintext, thus achieving the delivery.

In another embodiment, the transport unit is a robot module. The robot module identifies the minor address field in the comma address, obtains the physical address corresponding to the comma address and the ID information, and delivers the to-be-delivered item to the delivery address based on the physical address corresponding to the comma address and the ID information.

In this embodiment, the robot module is managed through the server. Therefore, the robot module can identify the minor address field in the comma address, obtain the physical address corresponding to the comma address and the ID information. A transportation capacity and a route planning capability of the robot module enables the to-be-delivered item to be delivered to the delivery address based on the physical address corresponding to the comma address and the ID information.

Therefore, whether the delivery is carried out by the delivery person or by the robot, an effect of the last-mile delivery proposed by the present disclosure can be achieved. However, the present disclosure preferably uses the robot module for the delivery. By combining a concept of spatial address digitization for the small space in the present disclosure and leveraging autonomous capabilities of the robot module, such as task planning and path planning, fully digitalized management can be achieved for delivery within the small space.

For the above two methods, specific delivery methods can be as follows:
1. The delivery person uses an APP/a mini-program on a mobile phone to identify a location identifier and ID information on a waybill, and then determines a precise delivery destination address and user ID information through the server. When there are a plurality of items, the delivery person uses the APP/mini-program to plan a route, delivers the items point by point, and notifies consignees to fetch the items upon reaching delivery destinations to complete one delivery.
2. When an unmanned vehicle system is used for delivery, an indoor robot identifies a to-be-delivered compartment and transfers it to an outdoor connection vehicle. The outdoor connection vehicle then moves the compartment from a courier station to a delivery connection location, and an indoor robot at the delivery connection location transports the compartment to a delivery destination. When there are a plurality of items, the outdoor connection vehicle plans a route, delivers the items point by point, and notifies consignees to fetch the items upon reaching delivery destinations to complete one delivery.

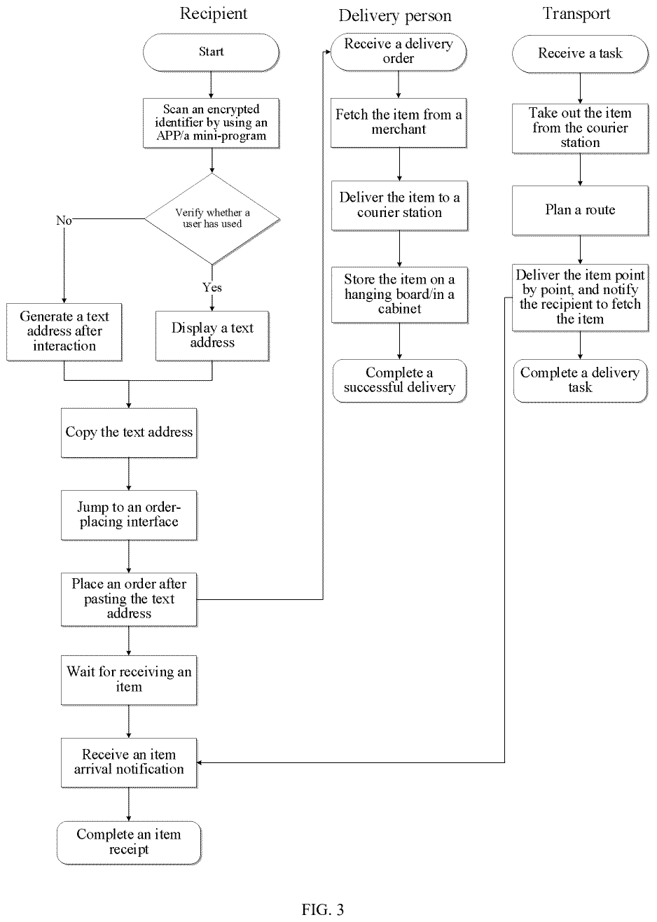

FIG. 3 shows a typical business process. In FIG. 3, a recipient scans an encrypted identifier by using an APP/a mini-program and verifies whether a user has previously used a comma address. If the user has previously used the comma address, a text address is displayed directly. If the user uses the comma address for the first time, the user is allowed to fill in a physical address, user ID information, and other personalized content. After obtaining the above information, a server generates and displays the text address. The user may copy the text address and jump to an order-placing interface. The order-placing interface may be an order-placing interface of an e-commerce platform or a logistics/courier platform, which is not limited herein. The user places an order after pasting the text address, and the recipient only needs to wait for receiving an item. After the sender places the order, the order can be generated on the e-commerce platform or the logistics/courier platform. A delivery person accepts a delivery order, fetches the item from a merchant, and delivers the item to a courier station. The courier station may be equipped with parcel lockers, atomic lockers, intelligent hanging boards, and the like. The intelligent hanging boards each are provided with hooks corresponding to comma addresses. The delivery person completes a successful delivery once the item is properly placed at the courier station. Upon receiving a notification from the courier station, a transport unit takes out the item from the courier station, plans a route for point-to-point delivery, and notifies the recipient to fetch the item, thereby completing an entire delivery process.

It should be noted that the above unmanned vehicle system includes the indoor robot and the outdoor connection vehicle. At outdoors, the indoor robot is mounted on the outdoor connection vehicle. At the delivery connection location, when there is a need to enter an indoor environment, the indoor robot is unloaded from the outdoor connection vehicle and delivers the item to a point location. In addition, the indoor robot is used in conjunction with the delivery compartment. When the delivery person delivers the item to the courier station, the item is placed into the delivery compartment. The indoor robot can identify the to-be-delivered compartment and parse its physical address and ID information.

Specifically, a complete delivery process includes the following specific steps:
S1: A plurality of indoor robot compartments are disposed in a courier station. A delivery person sorts items by address and places them in the indoor robot compartments.
S2. An indoor robot moves autonomously to locate a to-be-transported compartment, docks with the to-be-transported compartment, and lifts a cargo container to a certain height after alignment.
S3. The indoor robot carries the compartment to travel to an accommodation cavity of an outdoor connection vehicle, and lowers the compartment to connect the compartment with the outdoor connection vehicle after alignment.
S4. The indoor robot drives away from the outdoor connection vehicle and proceeds to transport a next compartment, and returns to a standby point after all the compartments are fully loaded.
S5. The outdoor connection vehicle carries the compartment and moves from the courier station to a delivery connection location.
S6. An indoor robot at the delivery connection location moves to the accommodation cavity of the outdoor connection vehicle, and lifts the compartment to separate it from the outdoor connection vehicle.
S7. The indoor robot carries the compartment, moves the compartment away from the outdoor connection vehicle, and transports the compartment to a delivery destination and a consignee.

It can be concluded that the present disclosure not only changes the last-mile delivery method, but also divides the space from a design perspective. For the large space, a traditional delivery service is still used. For the small space, the physical address is digitized and managed uniformly through the server. Under this framework, there may be diverse delivery forms within the small space, such as delivery by a specific delivery person and delivery by the robot, thereby overall enhancing efficiency of the last-mile delivery.

It should be understood that although the steps in the flowchart of FIG. 2 are sequentially displayed according to the arrows, these steps are not necessarily performed in the order indicated by the arrows. The execution order of these steps is not strictly limited, and these steps may be executed in other orders, unless clearly described otherwise. Moreover, at least some of the steps in FIG. 2 may include a plurality of sub-steps or stages. The sub-steps or stages are not necessarily executed at the same time, but may be executed at different times. The sub-steps or stages are not necessarily carried out sequentially, but may be executed alternately with other steps or at least some of sub-steps or stages of other steps.

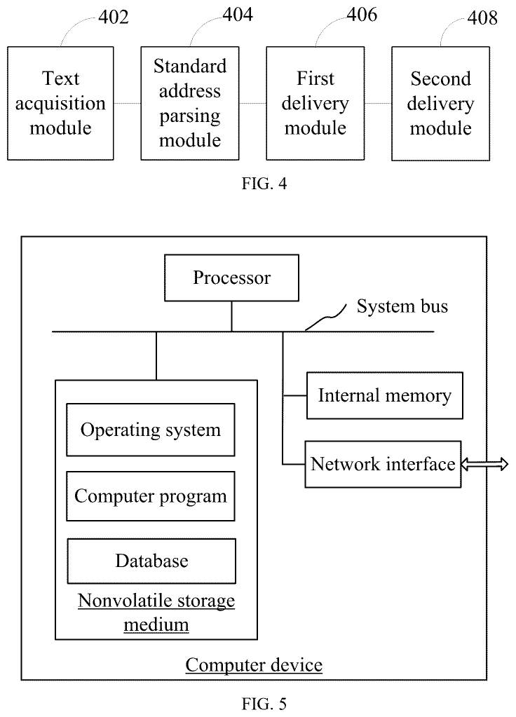

In an embodiment, as shown in FIG. 4, an item delivery apparatus based on a comma address is provided, including: text acquisition module 402, standard address parsing module 404, first delivery module 406, and second delivery module 408.

The text acquisition module 402 is configured to acquire an encrypted identifier of a comma address corresponding to a delivery address, and parse the encrypted identifier to obtain text information, where the comma address refers to a precise address including two levels of addresses: a major address and a minor address.

The standard address parsing module 404 is configured to obtain, based on the text information, the comma address that meets an address filling requirement of a delivery server.

The first delivery module 406 is configured to send the comma address to the delivery server, such that the delivery server performs dispatching based on a major address field in the comma address to deliver a to-be-delivered item to a courier station.

The second delivery module 408 is configured to dispatch a transport unit to the courier station, such that the transport unit identifies a minor address field in the comma address and delivers the to-be-delivered item to the delivery address.

In an embodiment, the text acquisition module 402 is further configured to receive a physical address and user-defined information that are filled in by a user through a handheld terminal, acquire the user ID information, and obtain, based on the physical address, the user-defined information and the user ID information, the encrypted identifier corresponding to the comma address.

In an embodiment, the text acquisition module 402 is further configured to receive interaction information obtained by the user scanning an address identifier corresponding to the delivery address through the handheld terminal, and obtain, based on the interaction information, the encrypted identifier of the comma address corresponding to the delivery address.

In an embodiment, the encrypted identifier is at least one of a QR code, a mini-program QR code, a barcode, and a recognizable code sequence.

In an embodiment, the major address field indicates a plaintext address pointing to the courier station.

In an embodiment, the minor address field indicates a ciphertext address pointing from the courier station to the delivery address.

In an embodiment, the minor address field includes a location identifier and user information; and the second delivery module 408 is further configured to perform matching based on the location identifier to obtain a physical address corresponding to the comma address, and perform matching based on the user information to obtain the user ID information.

In an embodiment, the user information is information filled in and registered by the user through the handheld terminal; or the user information is information generated based on preset conversion logic after the user ID information is acquired.

In an embodiment, the transport unit is a delivery person equipped with a handheld terminal; and the second delivery module 408 is further configured to enable the delivery person to identify the minor address field in the comma address through the handheld terminal, obtain the physical address corresponding to the comma address and the ID information, and deliver the to-be-delivered item to the delivery address based on the physical address corresponding to the comma address and the ID information.

In an embodiment, the transport unit is a robot module; and the second delivery module 408 is further configured to enable the robot module to identify the minor address field in the comma address, obtain the physical address corresponding to the comma address and the ID information, and deliver the to-be-delivered item to the delivery address based on the physical address corresponding to the comma address and the ID information.

For specific limitations on the item delivery apparatus based on a comma address, reference may be made to the above limitations on the item delivery method based on a comma address. Details are not described herein again. The modules of the item delivery apparatus based on a comma address may be implemented in whole or in part by software, hardware, or any combination thereof. The modules may be embedded in or independent of a processor of a computer device in a form of hardware, or stored in a memory of the computer device in a form of software, such that the processor can easily invoke and execute corresponding operations of the modules.

In an embodiment, a computer device is provided. The computer device may be a server, and an internal structure thereof may be as shown in FIG. 5. The computer device includes a processor, a memory, a network interface, and a database that are connected through a system bus. The processor of the computer device is configured to provide calculation and control capabilities. The memory of the computer device includes a nonvolatile storage medium, and an internal memory. The nonvolatile storage medium stores an operating system, a computer program, and a database. The internal memory provides an environment for running the operating system and the computer program in the nonvolatile storage medium. The database of the computer device is configured to store data such as a comma address, user information, and a mapping relationship. The network interface of the computer device is configured to communicate with an external terminal through a network. When the computer program is executed by the processor, an item delivery method based on a comma address is implemented.

Those skilled in the art may understand that the structure shown in FIG. 5 is only a block diagram of a part of the structure related to the solution of the present disclosure and does not constitute a limitation on a computer device to which the solution of the present disclosure is applied. Specifically, the computer device may include more or less components than those shown in the figure, or combine some components, or have different component arrangements.

In an embodiment, a computer device is provided, including a memory and a processor, where the memory stores a computer program, and the computer program is executed by the processor to implement the steps of the methods in the above embodiments.

In an embodiment, a computer-readable storage medium is provided. The computer-readable storage medium stores a computer program, and the computer program is executed by a processor to implement the steps of the methods in the above embodiments.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a storage, a database, or other mediums used in various embodiments provided in the present application may include a nonvolatile memory and/or a volatile memory. The nonvolatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As description rather than limitation, the RAM can be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchronization link (Synchlink) DRAM (SLDRAM), a Rambus direct RAM (RDRAM), a direct Rambus dynamic RAM (DRDRAM), and a Rambus dynamic RAM (RDRAM).

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

The above examples only express several embodiments of the present application, and the description thereof is more specific and detailed, but cannot be construed as a limitation on the scope of the present disclosure. It should be noted that, for a person of ordinary skill in the art, several variations and improvements can be made without departing from the concept of the present application, all of which fall within the protection scope of the present application. Therefore, the protection scope of this application shall be subject to the appended claims.

What is claimed is:

1. An item delivery method based on a comma address, comprising:
acquiring an encrypted identifier of a comma address corresponding to a delivery address, and parsing the encrypted identifier to obtain text information, wherein the comma address refers to a precise address comprising two levels of addresses: a major address field and a minor address field; and the comma address is managed uniformly by a server;
obtaining, based on the text information, the comma address that meets an address filling requirement of a delivery server;
sending the comma address to the delivery server, such that the delivery server performs dispatching based on the major address field in the comma address to deliver a to-be-delivered item to a courier station; and
dispatching a transport unit to the courier station, such that the transport unit identifies the minor address field in the comma address and delivers the to-be-delivered item to the delivery address;
wherein the acquiring the encrypted identifier of the comma address corresponding to the delivery address comprises:
acquiring pre-collected user identity (ID) information and a physical address of each management point location in a region, and obtaining, based on the physical address and the user ID information, the encrypted identifier of the comma address corresponding to the delivery address;
wherein the minor address field indicates a ciphertext address pointing from the courier station to the delivery address; and
the minor address field comprises a location identifier and user information;
wherein the identifying the minor address field in the comma address comprises:
performing matching based on the location identifier to obtain a physical address corresponding to the comma address; and
performing matching based on the user information to obtain the user ID information.

2. The item delivery method based on the comma address according to claim 1, wherein the acquiring the encrypted identifier of the comma address corresponding to the delivery address comprises:
receiving a physical address and user-defined information that are filled in by a user through a handheld terminal, acquiring the user ID information, and obtaining, based on the physical address, the user-defined information and the user ID information, the encrypted identifier of the comma address corresponding to the delivery address; or
receiving interaction information obtained by the user scanning an address identifier corresponding to the delivery address through the handheld terminal, and obtaining, based on the interaction information, the encrypted identifier of the comma address corresponding to the delivery address.

3. The item delivery method based on the comma address according to claim 1, wherein the encrypted identifier is at least one of a quick response (QR) code, a mini-program QR code, a barcode, and a recognizable code sequence.

4. The item delivery method based on the comma address according to claim 1, wherein the major address field indicates a plaintext address pointing to the courier station.

5. The item delivery method based on the comma address according to claim 1, wherein the user information is information filled in and registered by a user through a handheld terminal; or
the user information is information generated based on preset conversion logic after the user ID information is acquired.

6. The item delivery method based on the comma address according to claim 1, wherein the transport unit is a delivery person equipped with a handheld terminal; and
the transport unit identifies the minor address field in the comma address and delivers the to-be-delivered item to the delivery address, comprising:
identifying, by the delivery person, the minor address field in the comma address through the handheld terminal, and obtaining the physical address corresponding to the comma address and the ID information; and
delivering the to-be-delivered item to the delivery address based on the physical address corresponding to the comma address and the ID information.

7. The item delivery method based on the comma address according to claim 1, wherein the transport unit is a robot module; and
the transport unit identifies the minor address field in the comma address and delivers the to-be-delivered item to the delivery address, comprising:
identifying, by the robot module, the minor address field in the comma address, and obtaining the physical address corresponding to the comma address and the ID information; and
delivering the to-be-delivered item to the delivery address based on the physical address corresponding to the comma address and the ID information.

8. An item delivery apparatus based on a comma address, comprising:
a text acquisition module configured to acquire an encrypted identifier of a comma address corresponding to a delivery address, and parse the encrypted identifier to obtain text information, wherein the comma address refers to a precise address comprising two levels of addresses: a major address field and a minor address field; and the comma address is managed uniformly by a server;
a standard address parsing module configured to obtain, based on the text information, the comma address that meets an address filling requirement of a delivery server;
a first delivery module configured to send the comma address to the delivery server, such that the delivery server performs dispatching based on the major address field in the comma address to deliver a to-be-delivered item to a courier station; and
a second delivery module configured to dispatch a transport unit to the courier station, such that the transport unit identifies the minor address field in the comma address and delivers the to-be-delivered item to the delivery address, wherein the minor address field indicates a ciphertext address pointing from the courier station to the delivery address;
wherein the text acquisition module is further configured to acquire pre-collected user ID information and a physical address of each management point location in a region, and obtain, based on the physical address and the user ID information, the encrypted identifier of the comma address corresponding to the delivery address; and
the minor address field comprises a location identifier and user information; and the second delivery module is further configured to perform matching based on the location identifier to obtain a physical address corresponding to the comma address, and perform matching based on the user information to obtain the user ID information.

9. A computer device, comprising a memory and a processor, wherein the memory stores a computer program, and the processor executes the computer program to perform following steps:
acquiring an encrypted identifier of a comma address corresponding to a delivery address, and parsing the encrypted identifier to obtain text information, wherein the comma address refers to a precise address comprising two levels of addresses: a major address field and a minor address field; and the comma address is managed uniformly by a server;
obtaining, based on the text information, the comma address that meets an address filling requirement of a delivery server;
sending the comma address to the delivery server, such that the delivery server performs dispatching based on the major address field in the comma address to deliver a to-be-delivered item to a courier station; and
dispatching a transport unit to the courier station, such that the transport unit identifies the minor address field in the comma address and delivers the to-be-delivered item to the delivery address;
wherein the acquiring the encrypted identifier of the comma address corresponding to the delivery address comprises:
acquiring pre-collected user ID information and a physical address of each management point location in a region, and obtaining, based on the physical address and the user ID information, the encrypted identifier of the comma address corresponding to the delivery address;
wherein the minor address field indicates a ciphertext address pointing from the courier station to the delivery address; and
the minor address field comprises a location identifier and user information;
wherein the identifying the minor address field in the comma address comprises:
performing matching based on the location identifier to obtain a physical address corresponding to the comma address; and
performing matching based on the user information to obtain the user ID information.

10. The computer device according to claim 9, wherein the acquiring the encrypted identifier of the comma address corresponding to the delivery address comprises:
receiving a physical address and user-defined information that are filled in by a user through a handheld terminal, acquiring the user ID information, and obtaining, based on the physical address, the user-defined information and the user ID information, the encrypted identifier of the comma address corresponding to the delivery address; or
receiving interaction information obtained by the user scanning an address identifier corresponding to the delivery address through the handheld terminal, and obtaining, based on the interaction information, the encrypted identifier of the comma address corresponding to the delivery address.

11. The computer device according to claim 9, wherein the encrypted identifier is at least one of a QR code, a mini-program QR code, a barcode, and a recognizable code sequence.

12. The computer device according to claim 9, wherein the major address field indicates a plaintext address pointing to the courier station.

13. The computer device according to claim 9, wherein the user information is information filled in and registered by a user through a handheld terminal; or
the user information is information generated based on preset conversion logic after the user ID information is acquired.

14. The computer device according to claim 9, wherein the transport unit is a delivery person equipped with a handheld terminal; and
the transport unit identifies the minor address field in the comma address and delivers the to-be-delivered item to the delivery address, comprising:
identifying, by the delivery person, the minor address field in the comma address through the handheld terminal, and obtaining the physical address corresponding to the comma address and the ID information; and
delivering the to-be-delivered item to the delivery address based on the physical address corresponding to the comma address and the ID information.

15. A computer-readable storage medium storing a computer program, wherein the computer program is executed by a processor to perform following steps:
acquiring an encrypted identifier of a comma address corresponding to a delivery address, and parsing the encrypted identifier to obtain text information, wherein the comma address refers to a precise address comprising two levels of addresses: a major address field and a minor address field; and the comma address is managed uniformly by a server;
obtaining, based on the text information, the comma address that meets an address filling requirement of a delivery server;
sending the comma address to the delivery server, such that the delivery server performs dispatching based on the major address field in the comma address to deliver a to-be-delivered item to a courier station; and
dispatching a transport unit to the courier station, such that the transport unit identifies the minor address field in the comma address and delivers the to-be-delivered item to the delivery address;
wherein the acquiring the encrypted identifier of the comma address corresponding to the delivery address comprises:
acquiring pre-collected user ID information and a physical address of each management point location in a region, and obtaining, based on the physical address and the user ID information, the encrypted identifier of the comma address corresponding to the delivery address;
wherein the minor address field indicates a ciphertext address pointing from the courier station to the delivery address; and
the minor address field comprises a location identifier and user information;
wherein the identifying the minor address field in the comma address comprises:
performing matching based on the location identifier to obtain a physical address corresponding to the comma address; and
performing matching based on the user information to obtain the user ID information.

16. The computer-readable storage medium according to claim 15, wherein the acquiring the encrypted identifier of the comma address corresponding to the delivery address comprises:
receiving a physical address and user-defined information that are filled in by a user through a handheld terminal, acquiring the user ID information, and obtaining, based on the physical address, the user-defined information and the user ID information, the encrypted identifier of the comma address corresponding to the delivery address; or
receiving interaction information obtained by the user scanning an address identifier corresponding to the delivery address through the handheld terminal, and obtaining, based on the interaction information, the encrypted identifier of the comma address corresponding to the delivery address.

17. The computer-readable storage medium according to claim 15, wherein the encrypted identifier is at least one of a QR code, a mini-program QR code, a barcode, and a recognizable code sequence.

18. The computer-readable storage medium according to claim 15, wherein the major address field indicates a plaintext address pointing to the courier station.

19. The computer-readable storage medium according to claim 15, wherein the user information is information filled in and registered by a user through a handheld terminal; or
the user information is information generated based on preset conversion logic after the user ID information is acquired.

20. The computer-readable storage medium according to claim 15, wherein the transport unit is a delivery person equipped with a handheld terminal; and
the transport unit identifies the minor address field in the comma address and delivers the to-be-delivered item to the delivery address, comprising:
identifying, by the delivery person, the minor address field in the comma address through the handheld terminal, and obtaining the physical address corresponding to the comma address and the ID information; and
delivering the to-be-delivered item to the delivery address based on the physical address corresponding to the comma address and the ID information.
